(19) United States
(12) Patent Application Publication
(10) Pub. No.: US 2007/0226151 A1
(43) Pub. Date: Sep. 27, 2007

(54) Method for Processing a Cashless Payment Transaction

(75) Inventors: Michael Baldischweiler, Munchen (DE); Klaus Finkenzeller, Unterfohring (DE)

Correspondence Address: BACON & THOMAS, PLLC, 625 SLATERS LANE, FOURTH FLOOR, ALEXANDRIA, VA, 22314, US

(73) Assignee: GIESECKE & DEVRIENT GMBH, Munchen (DE)

(21) Appl. No.: 10/575,964

(22) PCT Filed: Oct. 12, 2004
(86) PCT No.: PCT/EP04/11423

§ 371 Date: May 2, 2007

(30) Foreign Application Priority Data
Oct. 15, 2003 (DE) 103 47 990.2

(51) Int. Cl. G06Q 99/00

(52) U.S. Cl. 705/61

(57) ABSTRACT

Proposed is a method for processing a cashless payment transaction between an owner of a personal electronic means of payment (1, 12) and a payee. The special feature of the inventive method is that at a first time (t1) a data record is transmitted from the owner's personal electronic means of payment (1, 12), directly or by means of a personal device (8) of the owner, to an electronic intermediate carrier (2) which is formed as a physically separate unit with regard to the owner's personal electronic means of payment (1, 12), and at a second time (t2) which is later than the first time (t1) the data record or data derived therefrom are transmitted from the electronic intermediate carrier (2) to the payee.

This invention relates to a method for processing a cashless payment transaction. The invention relates further to a system for processing a cashless payment transaction.

Cashless payment transactions are diversely employed and already known in a large number of embodiments. For example, DE 199 57 660 A1 discloses a method for charging the price of travel for the use of public transport. In this method a passenger loads up a memory element provided on his fare card resembling a check card, using cash or a credit card, at a machine connected to a head office. The public transport vehicle emits metering pulses during the journey, which are recorded by a receiver integrated in the fare card and cause in each case an amount to be debited to the credit stored in the memory element.

DE 198 42 555 A1 discloses a method and apparatus for collecting an amount for authorized use of an area and/or service. At the onset of use, a value transponder containing an individual identification number and a certain debitable amount is connected with a read/write station of a terminal. The terminal has stored therein the identification number of the value transponder as well as the date and time of the onset of use. Further, the terminal blocks a security deposit amount on the value transponder. After termination of use, the value transponder is reconnected with the terminal, and the terminal debits the amount charged for the utilization time and eliminates the blockage of the security deposit amount.

Further, portable payment transaction terminals are known, e.g. from DE 299 02 057 U1, which allow amounts of money to be debited to chip cards with cash card functionality. To effect the data exchange between a chip card and a terminal it is possible, according to a proposal in WO 02/067211 A1, to use personal digital assistants (PDAs) which in particular guarantee secure data transmission. To visualize the data exchange between terminal and chip card it is further possible, according to DE 198 41 862 A1, to use mobile telephones. These proposals are all based on the concept of a user directly and actively causing a defined amount to flow to a payee when effecting a payment. The terminals used on the part of the payee are person-related and non-transferable.

It was further proposed in DE 198 42 555 A1 to implement a flexible collection of parking fees using transponders by fixing the amount of the fee to be paid only after the end of the parking use. First, a prepaid parking fee is blocked on the transponders. If the transponder is presented at a reading machine again before the end of the maximum parking time, only part of the blocked amount is actually collected. This method is based on the use of stationary payment machines. It does not allow the processing of a mobile payment between a person and a spatially separate recipient.

Despite the many known embodiments, cashless payment transactions are still subject to a number of restrictions. For example, due to the danger of abuse it is generally undesirable to let go of means of cashless payment except for data transmission with a terminal, so that it is very difficult to process a cashless payment in the absence of the owner of the means of cashless payment.

The invention is based on the problem of further improving the processing of cashless payment transactions.

This problem is solved by a method having the feature combination of claim 1.

The inventive method relates to the processing a cashless payment transaction between an owner of a personal electronic means of payment and a spatially separate payee using an intermediate carrier. The special feature of the inventive method is that, at a first time, a data record is transmitted from the owner's personal electronic means of payment, directly or by means of a personal device of the owner, to an electronic intermediate carrier which is formed as a physically separate unit with respect to the owner's personal electronic means of payment and, at a second time, which is later than the first time, a check is performed as to whether the data record or data derived therefrom are suitable for effecting the intended payment transaction. Only then are the data record or data derived therefrom transmitted from the electronic intermediate carrier to the payee.

The invention has the advantage that the cashless payment can be prepared by the owner of the personal electronic means of payment without using the payee's infrastructure and without any need to make contact with the payee. The owner is thus not subject to any restrictions with regard to the spatial availability of such an infrastructure, or exposed to any waiting periods for utilizing the infrastructure. Moreover, he need not necessarily exactly determine an amount to be paid in advance. Instead, it is advantageously possible to provide both overpayments to be refunded and the possibility of additional payment after a check by the recipient. It can advantageously be left to the recipient to procure the reference information required for ascertainment. Payment transactions can furthermore be easily provided with additional information, e.g. a date or place. A further advantage is that the payment can be effected in the owner's absence and this does not require his personal electronic means of payment.

The data record can be secured cryptographically. In particular, the data record can depend on individual data of the electronic intermediate carrier and/or a consecutive character string. This can firstly prevent improper copying of the data record and secondly facilitate tracking. Further, there is also the possibility of encrypting the data record by means of a public key of the payee. This has the advantage that the data record can be used exclusively by the payee. Furthermore, it is advantageous if the data record depends on personal data of the owner of the personal electronic means of payment. This provides the payee with the possibility of determining the origin of the data record, so that the payment can be effected for example by direct debit. There is likewise the possibility of the data record representing at least one amount of money or at least one unit of value.

The data record can, at the second time, be deleted or invalidated completely or with regard to the data derived therefrom in the electronic intermediate carrier. This can prevent the data record or the data derived therefrom from being used several times for different payment transactions. In particular, the inventive method can be designed so that the electronic intermediate carrier is not in the possession of the owner of the personal electronic means of payment at the second time. This permits payment transactions in the absence of the owner of the personal electronic means of payment, whereby the risk of abuse is limited to the equivalent value represented by the data record transmitted to the electronic intermediate carrier.

The data transmission at the first time and/or at the second time is preferably effected contactlessly. The inventive method can be used for example in an application by which the cashless payment transaction pays the postage for mail. It is thereby possible to store information about the time and/or place of delivery of the mail in the electronic intermediate carrier.

The inventive system for processing a cashless payment transaction has a personal electronic means of payment of an owner, a transportable electronic intermediate carrier formed to be physically separate from the personal electronic means of payment, and a receiving device of a payee. The special feature of the inventive system is that the personal electronic means of payment is formed so that it can transmit a data record directly to the electronic intermediate carrier, or a personal device of the owner is provided for transmitting the data record from the personal electronic means of payment to the electronic intermediate carrier. The electronic intermediate carrier is preferably designed for multiple use. Upon use to pay postage, the recipient of mail might then for his part use a received electronic intermediate carrier, after topping it up again, for franking for example.

The electronic intermediate carrier is preferably formed as a transponder. Transponders are economical to produce and do not require any mechanical contacting in the course of a data transmission. The personal electronic means of payment can be formed as a chip card, in particular as an electronic purse or as a security module of a mobile telephone.

The invention will hereinafter be explained in more detail with reference to embodiments shown in the drawing.

The Figures are described as follows:

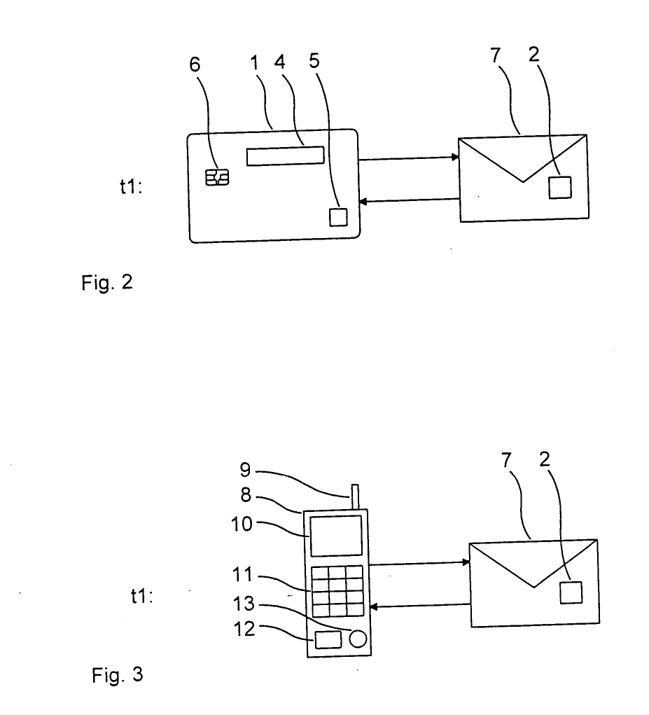

FIG. 2 a schematic diagram for a possible implementation of a direct data transmission between the cash card and the transponder at the first time for paying postage

FIG. 3 a schematic diagram for a possible implementation of a data transmission integrating a mobile telephone, and

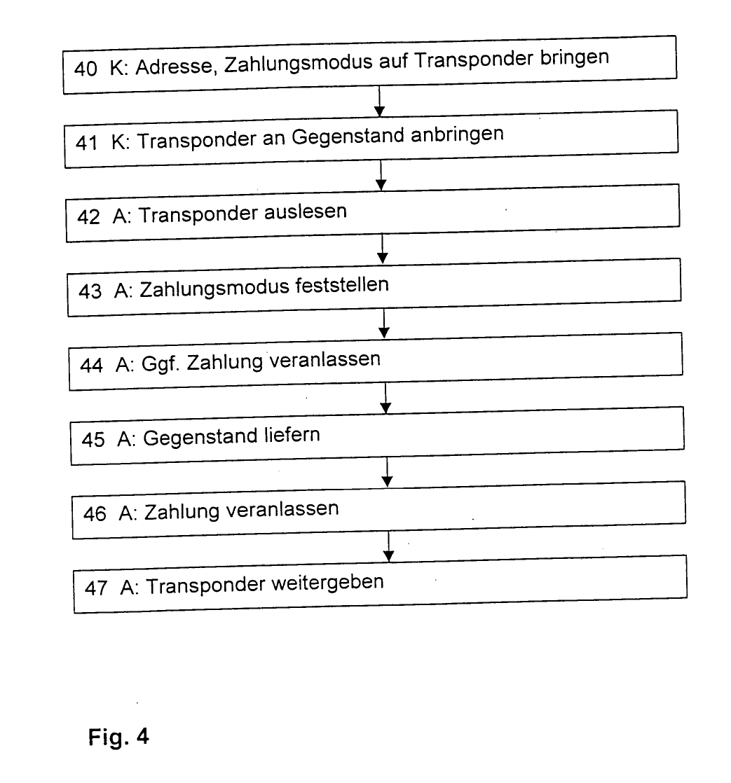

FIG. 4 a flow chart to illustrate a possible application of the inventive solution.

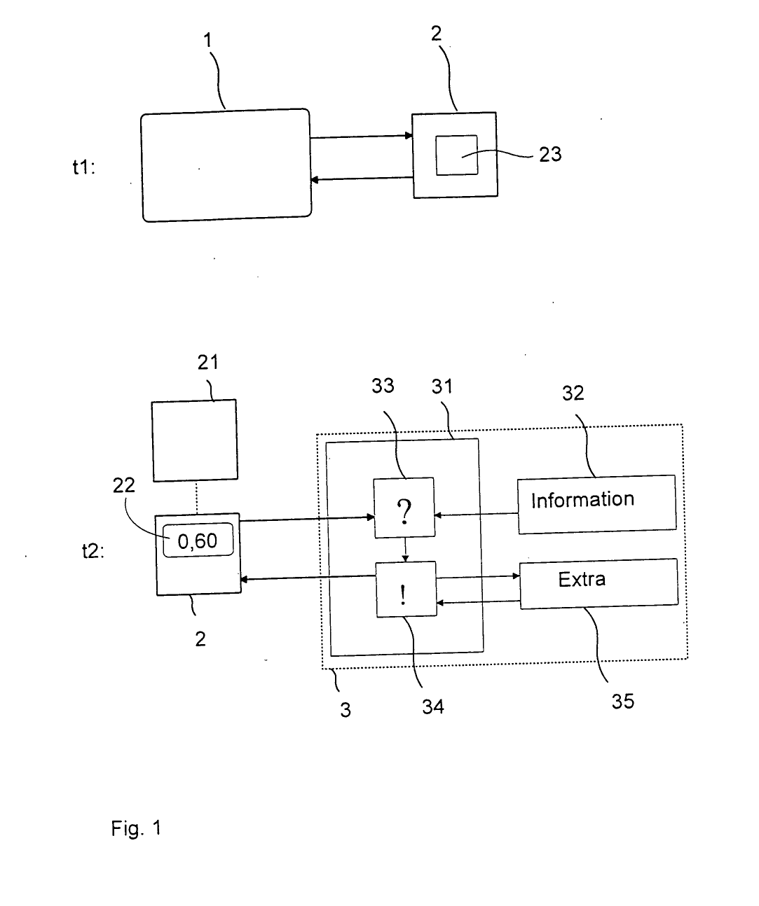

FIG. 1 shows a schematic diagram for an inventive processing of a cashless payment transaction. The upper area of FIG. 1 shows a per se known cash card 1, i.e. a chip card with a purse function, and a transponder 2 at a first time t1. The transponder 2 is formed so as to be small, transportable and preferably reusable; it can be designed in the manner of a label for example. The transponder has a nonvolatile memory 23 for receiving data records and applications. It can further have a display device 22, as indicated in the lower part of FIG. 1, for optically visualizing information on a data record located on the transponder 2.

At the first time t1 the cash card 1 and the transponder 2 perform a data exchange with each other, as indicated by corresponding arrows. During said data exchange the cash card 1 transmits a data record to the transponder 2. A data record is understood here to mean the data information assigned to a performance; a data record can actually also comprise a plurality of data records in information technology. A performance is understood here to mean an object 21, goods or a service, for the procurement of which a payment must be made to a payee.

To receive a payment, the payee has a receiving device 3 constructed of a checking device 31 and additional components 32, 35. The additional components 32, provide in particular reference information for checking a data record. Checking device 31 and additional components 32, 35 can be formed so as to be integrated or else spatially separate. In a preferred embodiment of the invention, the transponder 2 is connected at least temporarily to an object 21 to assign thereto a value or an indication of use.

The lower area of FIG. 1 shows the transponder 2, an object 21 connected thereto, and a receiving device 3 of a payee at a second time t2. The second time t2 is later than the first time t1, so that at the second time t2 the transponder 2 already has the data record transmitted from the cash card 1.

At the second time t2 the transponder 1 and the receiving device 3 perform a data exchange. This is again indicated by arrows. During said data exchange the data record stored in the transponder 2 is transmitted to the receiving device 3. In the checking device 31 of the receiving device 3 the data record is first checked, step 33, as to whether it correctly renders the performance. It is typically checked by comparison with a reference data record whether the data record corresponds to a payment amount required for procuring the performance or permits collection of a corresponding payment amount. The reference information required for the check is received by the checking device 31 from an information component 32 which for its part determines the information for example by linking the quality of the object 21 with a tabular set of rules.

If the data record renders the performance correctly, the receiving device 3 prepares the debit of the amount of money corresponding to the performance to the transponder 2, or the collection by a method of payment determined by the data record. There is the possibility of either a complete debit or an only partial debit. According to the extent of the debit, the amount of money or units of value are deleted or marked as invalid in the transponder 2, step 34. At the same time, remarks on the circumstances of the debit can also be entered on the transponder 2.

If the data record does not correspond to the performance as given, the checking device 32 conveys this in a step 34 to an extra component 35 which there-upon specifies the further procedure for the particular case. In simple fashion it can be provided that corresponding information together with a specification of measures is written to the transponder 2. If a short amount is ascertained, for example, an entry can be made in the transponder 2 that an additional payment is still required by another method of payment.

The activation of the extra component 35 can also be provided in the no-error case to write additional information, e.g. checking information or notifications, to a transponder 2.

Data records transmitted to transponders 2 or received from transponders 2 can also be stored in the receiving device 3. For example, they can be stored in the receiving device 3 on a removable, portable data carrier, in particular in a chip card not shown in the drawing.

Depending on the application, the data record can have different contents. In a first embodiment of the inventive method, the data record contains an amount of money or units of value.

In one embodiment, the transponder 2 has its own display device 22 for optically outputting information in connection with a data record stored on the transponder 2. The display device 22 can be e.g. a bistable display means in the manner of an electronic paper which is supplied with energy by a receiving device 3 for the duration of a data exchange therewith and whose setting persists even without energy supply. The display device 22 can be used to display for example a money value representing e.g. postage or a purchase price, as indicated in FIG. 1, but also a state of validity, an indication of an additional payment that might be necessary, or an indication of a recipient of an object 21 to which the transponder 2 is connected.

To permit the amount of money or units of value to be topped up and debited, the transponder 2 can be itself equipped with corresponding functions and operating facilities. However, the required functions and operating facilities are preferably not set up in the transponder 2, but in the cash card 1, so that the transponder 2 itself can be formed very simply and need not have any special functionalities. To implement a copy protection of the amount of money or units of value stored in the transponder 2, a serial number or another feature of the transponder 2 can for example be included in the data record transmitted from the cash card 1 to the transponder 2 at the time t1.

The transponder 2 can be used for example for franking a letter. In this case, e.g. the date and place of franking effected by the debit can be additionally noted and the transponder 2 in this way provided with an electronic stamp corresponding to a conventional stamp overprint on a postage stamp.

In a second embodiment of the inventive method, the cash card 1 does not transmit a data record with an amount of money or units of value to the transponder 2. Instead, for example the serial number or another feature of the transponder 2 is first read and signed with a personal key of the owner of the cash card 1 that is stored on the cash card 1. To facilitate later tracking, a consecutive number can be taken into account, for example, during creation of the data record. Further, the data record can be encrypted by a public key method using a public key of the intended payee in order to prevent improper use of the data record. This procedure can also be applied in the first embodiment and extended to the use of several public keys, in particular also the public key of the owner of the cash card 1. It is thereby also possible to secure the debit function for the amount of money or units of value by means of a public key. The data record produced in the described way is then written to the transponder 2.

At the second time t2 the data record is transmitted to the payee's receiving device 3. If the data record is present in encrypted form, it is subsequently decrypted with the payee's private key. Using the signature contained in the data record, the owner of the cash card 1 is determined. Further, the receiving device 3 determines the payment amount to be furnished for the performance. The determined payment amount is thereupon collected cashlessly from the previously determined owner of the cash card 1. This can be done for example by debiting to a bank account or a specially provided credit account.

Unlike the first embodiment of the inventive method, the second embodiment requires that the owner of the cash card 1 previously logs in with the payee. In this log-in the required data, programs and keys are loaded onto the cash card 1. Since the second embodiment of the inventive method makes no use of specific cash card functions, a chip card without a cash card function issued by the payee can also be used, for example, instead of the cash card 1.

In neither the first nor the second embodiment of the inventive method is the payment to the payee made before the data transmission is effected between the transponder 2 and the payee's receiving device 3, i.e. before the time t2. During the data transmission between the cash card 1 and the transponder 2 at the time t1 payment-preparing measures are already performed and, in the case of the first embodiment, an amount of money or units of value also transmitted from the cash card 1 to the transponder 2. However, according to the invention, there is at this time either a direct data transmission between the cash card 1 and the transponder 2 involving no further devices, or the data transmission is effected in indirect fashion exclusively by means of personal devices of the owner of the cash card 1. Thus, at the time t1 there is in no case already an outflow of the amount of money or units of value or a debit permission to third parties, in particular to the intended payee.

Hereinafter both a variant with direct data transmission and a variant with indirect data transmission will be explained more closely by the example of a cashless payment of postage.

FIG. 2 shows a schematic diagram for a possible implementation of a direct data transmission between the cash card 1 and the transponder 2 at the first time t1 for paying postage. In this case, the cash card 1 has a display device 4 for displaying information and a push-button 5 for making an input, for example for influencing the data to be transmitted and for starting the data transmission. In a development of the cash card 1, a plurality of push-buttons 5 are provided which form for example a numeric keyboard. Further, the cash card 1 also has a contact surface 6, which is not used in the present case, however, since the data transmission is effected contactlessly. Furthermore, the cash card 1 also has a number of components not shown in the drawing, such as a transmitting/receiving device designed for contactless communication with the transponder 2, a voltage supply and, above all, an integrated circuit which executes all processes. For this purpose, the integrated circuit of the cash card 1 has software for determining the amount of postage for example.

The transponder 2 is part of a letter 7 that is to be franked with the help of the transponder 2. For example, the transponder 2 is designed to be so small and in particular so flat that it can be embedded into the paper or cardboard material of the envelope. Franking the letter 7 can be done by transmitting an amount of money corresponding to the postage or a signature for a later debit of the postage to the cash card 1 to the transponder 2. For franking the letter 7 the payment is then made to the payee, in this case the post office, in the way described for FIG. 1 in each case.

The transponder 2 is preferably suitable for multiple use. For this purpose, it is detachably connected to the envelope or fastened to the mail to be franked and can be topped up again for further mail after franking. Reuse can be effected in particular by the recipient of mail. So that topping up can be trouble-free, the software of the cash card 1 includes a function by which the cash card 1 can ascertain whether the transponder 2 is still topped up or already franked; the software optionally permits the transponder 2 to be topped up again.

FIG. 3 shows a schematic diagram for a possible implementation of an indirect data transmission integrating a personal device 8 of the owner of a means of payment 12. The personal device 8 is an intelligent device 8 in the form of a mobile telephone 8. The execution as a mobile telephone is only by way of example. The intelligent device 8 can likewise be present in any other embodiments that, under the owner's control, allow a data communication with a transponder 2 on which a desired application is set up, and thus an indirect data transmission from the means of payment 12 to the transponder 2. It is suitable to use for example so-called PDAs (personal digital assistants), electronic schedulers, laptop computers or also home computers. The mobile telephone 8—standing for an intelligent device—has an antenna 9, a display device 10, a keyboard 11, a security module 12 and a contactless reading device 13 for close-range communication with a transponder 2, preferably in the form of an RFID reading device or an NFC (near field communication) interface.

As in FIG. 2, the application taken as a basis is again the payment of postage. The data record for the transponder 2 is now generated by the security module 12 which in this case functions as the means of payment. It has similar functionalities to the cash card 1 in this regard, but is not able to transmit the data record to the transponder 2 contactlessly itself, instead making use of the mobile telephone 8 for this purpose. In particular, the display device 10 and the keyboard 11 of the mobile telephone 8 can also be used here. However, the data transmission is not effected over the usual air interface of the mobile telephone 8 used for transmitting telephone calls, but with the help of the contactless reading device 13 specially provided for communication with the transponder 2. The mobile phone network is not involved in the data transmission between the security module 12 and the transponder 2. Regarding the content of the transmitted data, the remarks on FIG. 2 apply accordingly.

In a variation, the mobile telephone 8 has as the means of payment 12 a dual interface card which can communicate both via touching electrical contacting and contactlessly. In this variation, the contactless reading device 13 can be omitted by using the contactless interface of the dual interface card for communication with the transponder 2.

As explained, further information can be stored in the transponder 2, besides the data required for processing the cashless payment, in all embodiments of the inventive method. In the above-described franking of letters 7 or other mail, said information can relate for example to the place and time of delivery of the letter 7. Such information can further also be entered by means of a further, separate component of the receiving device 3, for example by means of a contactless transmitting/receiving device, which is disposed in the vicinity of the deposit slot of a mail box.

Besides cashless payment of postage, the invention can be used for a number of further applications. One possible application is for example for making out an electronic check. For this purpose, a data record can be written to the transponder 2, which is signed with the private key of the owner of the cash card 1 or another chip card, and optionally encrypted with the public key of the intended payee. The data record then constitutes a guarantee of payment for the intended payee. Another possible use of the invention is for making reservations, e.g. for the theater or public transport.

A further possible application of the invention is illustrated in the flow chart in FIG. 4. The transponder 2 is used here to install a system for delivering objects 21 of daily use, e.g. beverages in crates. The objects 21 are designed for simple mechanical fastening of a transponder 2 of a customer K. The customer provides the transponder 2 in a way as described above with a data record which contains firstly a delivery address and secondly a mode for payment of a performance, step 40. The payment mode can be for example cash on delivery, or else partial or advance payment in cash value. On the premises of a supplier A the customer fastens the thus prepared transponder 2 detachably to an object 21 which he wishes to acquire, step 41. Using a suitable receiving device 3 the supplier reads the transponder 2 later at a suitable time, step 43, and determines payment mode and delivery address, step 44. According to the information found, the supplier effects payment and delivery, steps 45, 46. The transponder 2 can then be given back to the customer, or else handed over to any other customer, step 47.

In view of the different potential applications of the transponder 2, it is provided in a development of the invention that the communication partner of the transponder 2, for example the cash card 1 or the mobile telephone 8 with the security module 12, recognizes the purpose for which the transponder 2 is being used and starts an associated software application e.g. by applets.

According to another development of the invention, the functionality required for communication with a transponder 2, i.e. the required data, programs and keys, is stored as an application on the transponder 2 and output from there to a personal means of payment 1 or an intelligent device 8 when required. In the nonvolatile memory 23 of the transponder 2 a corresponding area is kept available for this purpose and expediently specially secured against unauthorized access, e.g. by the use of one-time passwords. Transponder 2 and corresponding device 1, 8 each have a defined interface over which an application can be transmitted. Interface and applications are preferably secured against tampering by cryptographic measures, e.g. by the use of asymmetrical encryption methods in connection with certificates. For example, applications can be signed with the private key of an issuer of the application for protection against fraud or against viruses. The signatures must then be verified by the usual procedures. The functionality stored on a transponder 2 is transmitted to the particular device 1, 8 before the first use of a personal means of payment 1 or an intelligent device 8 for transmission of a data record to a transponder 2. Transmitted applications can remain permanently in the receiving device 1, 8 or be deleted after each application. Since an application at the same time provides the functionality for use, this development allows a new application for a transponder 2 to be implemented and marketed quickly and easily.

1. A method for cashless processing of a transaction for paying for a service between an owner of a personal electronic means of payment and a payee, comprising the steps:
transmitting at a first time (t1) a data record assigned to the service from the owner's personal electronic means of payment, directly or by means of a personal device of the owner, to an electronic intermediate carrier which is formed as a transferable unit physically separate from the owner's personal electronic means of payment, and
at a second time (t2) which is later than the first time (t1), checking the data record or data derived therefrom by a receiving device of the payee as to whether the service was rendered correctly.

2. The method according to claim 1, including the step:
transmitting the data record or data derived therefrom from the electronic intermediate carrier to the payee.

3. The method according to claim 1, including the step of securing the data record cryptographically.

4. The method according to claim 1, wherein any of the the data record depends on at least one of individual data of the electronic intermediate carrier and a consecutive character string.

5. The method according to claim 1, including encrypting the data record by means of a public key of the payee.

6. The method according to claim 1, wherein the data record depends on personal data of the owner of the personal electronic means of payment.

7. The method according to claim 1, wherein the data record represents at least one amount of money or at least one unit of value.

8. The method according to claim 1, including the step of deleting or invalidating the data record at the second time (t2) completely or with regard to the data derived therefrom in the electronic intermediate carrier.

9. The method according to claim 1, wherein the electronic intermediate carrier is not in the possession of the owner of the personal electronic means of payment at the second time (t2).

10. The method according to claim 1, wherein the data transmission is effected contactlessly at least one of the first time (t1) and at the second time (t2).

11. The method according to claim 1, including the step of using the cashless payment transaction is used for paying postage for mail.

12. The method according to claim 11, wherein the intermediate carrier is fastened detachably to mail.

13. The method according to claim 11, wherein information on at least one of the time and place of the delivery of the mail is stored in the electronic intermediate carrier.

14. The method according to claim 1, including visualizing that information in connection with the data record on the intermediate carrier.

15. The method according to claim 1, including fastening the intermediate carrier detachably to an object.

16. The method according to claim 1, including transmitting the functionality required for transmitting a data record from the personal means of payment or a personal device to the intermediate carrier from the intermediate carrier to the personal means of payment or the personal device.

17. A system for cashless processing of a transaction for paying for a service, comprising a personal electronic means of payment of an owner, an impersonal electronic intermediate carrier arranged to be physically separate from the personal electronic means of payment, and a receiving device of a payee, wherein the personal electronic means of payment is arranged to transmit a data record assigned to the service directly to the electronic intermediate carrier, or a personal device of the owner is provided for transmitting the data record from the personal electronic means of payment to the electronic intermediate carrier, and the receiving device is arranged to check the data record as to whether it renders the service correctly.

18. The system according to claim 17, wherein the electronic intermediate carrier is formed as a transponder.

19. The system according to claim 17, wherein the electronic intermediate carrier is set up for repeated transmission of data records.

20. The system according to claim 17, wherein in that the functionality required for transmitting a data record from the personal means of payment or a personal device to the intermediate carrier is stored as an application on the electronic intermediate carrier.

21. The system according to claim 17, wherein the electronic intermediate carrier has a display device for visualizing information in connection with a data record.

22. The system according to claim 17, wherein the personal device is an intelligent device having a reading device for near field communication with a transponder.

23. The system according to claim 17, wherein the intelligent device is a mobile telephone.

24. The system according to one of claim 17, wherein the personal electronic means of payment is formed as a chip card, or as a security module of a mobile telephone.

25. The system according to claim 17, wherein the receiving device has a checking device as well as at least one additional component which provides reference information for checking a data record.
